(19) United States
(12) Patent Application Publication
(10) Pub. No.: US 2026/0115758 A1
(43) Pub. Date: Apr. 30, 2026

(54) SHEET EMBELLISHING SYSTEM AND NON-TRANSITORY STORAGE MEDIUM STORING MACHINE-READABLE PROGRAM

(71) Applicant: Duplo Corporation, Sagamihara-shi (JP)

(72) Inventors: Naoto Ozaki, Sagamihara-shi (JP); Kazutaka Tsunoda, Sagamihara-shi (JP); Takanori Kaneda, Sagamihara-shi (JP)

(73) Assignee: Duplo Corporation, Sagamihara-shi (JP)

(21) Appl. No.: 19/371,592

(22) Filed: Oct. 28, 2025

(30) Foreign Application Priority Data
Oct. 31, 2024 (JP) 2024-192426
May 15, 2025 (JP) 2025-082268

(51) Int. Cl. B05D 3/06; B05C 13/00

(52) U.S. Cl. CPC B05D 3/067; B05C 13/00

(57) ABSTRACT

A sheet embellishing system that subjects a sheet to embellishment, while conveying the sheet, includes a varnish-discharging unit that discharges and applies ultraviolet curable varnish to the sheet, a UV irradiation unit that is movable to a first position and a second position downstream in a sheet conveying direction from the first position and upstream from a transfer device, and that performs irradiation by UV rays to applied varnish, and a position determining unit that determines at which of the first position and the second position the UV irradiation unit is situated. The transfer device executes transfer processing on the varnish irradiated by UV rays. A total light intensity of UV rays by which the varnish is irradiated by the UV irradiation unit is smaller when the UV irradiation unit is determined to be at the first position as compared to when determined to be at the second position.

### BACKGROUND OF THE INVENTION

### 1. Field of the Invention

The present disclosure relates to a sheet embellishing system, and a non-transitory storage medium storing a machine-readable program.

### 2. Description of the Related Art

Technology, in which transfer material such as foil or the like is transferred onto varnish applied to the surface of a sheet, is known. There also is known technology in which a transfer web is brought into close contact with varnish applied onto the surface of a sheet, thereby transferring surface features of the transfer web to the varnish. Such technology is capable of forming varnish-coated regions that are only coated by varnish, and transfer regions where transfer processing such as foil stamping or the like is executed on varnish, on the surface of the sheet.

Varnish-coated regions are formed by, for example, performing full-curing of varnish in the varnish-coated regions, using a UV irradiation unit for full-curing, which performs complete full-curing of varnish. Transfer regions are formed by, for example, performing half-curing of varnish using a UV irradiation unit for half-curing, which performs curing of varnish to a half-cured state, at a level of not being completely cured, and while the transfer web is in close contact with this varnish in the half-cured state, performing full-curing of the varnish, using a separate UV irradiation unit. Japanese Unexamined Patent Application Publication No. 2021-167109 describes such technology.

In conventional sheet embellishing systems, there is a need to provide both a UV irradiation unit for full-curing of varnish-coated regions and a UV irradiation unit for half-curing of transfer regions. This has led to high costs of sheet embellishing systems.

### SUMMARY OF THE INVENTION

The present disclosure has been made in light of the foregoing circumstances, and an exemplary object of an aspect thereof is to provide sheet embellishing technology that enables sheet embellishing to be performed at low costs.

In order to solve the foregoing problem, a sheet embellishing system according to an aspect of the present disclosure is a sheet embellishing system that subjects a sheet to embellishment while conveying the sheet. The sheet embellishing system includes a varnish-discharging unit that discharges varnish that is ultraviolet (UV) curable, and applies the varnish to the sheet, a UV irradiation unit that is capable of being disposed at a first position, and a second position that is on a downstream side in a conveying direction of the sheet from the first position and on an upstream side in the conveying direction from a position at which a transfer device is disposed, and that performs irradiation of the varnish that is applied by UV rays, the transfer device that executes predetermined transfer processing on the varnish irradiated by the UV rays, and a position determining unit that determines at which of the first position and the second position the UV irradiation unit is situated. A total light intensity of UV rays by which the varnish is irradiated by the UV irradiation unit is smaller in a case in which the UV irradiation unit is determined to be situated at the first position as compared to a case in which the UV irradiation unit is determined to be situated at the second position.

A sheet embellishing method according to another aspect of the present disclosure is a sheet embellishing method that uses a sheet embellishing system that subjects a sheet to embellishment while conveying the sheet, and that includes
a varnish-discharging unit that discharges varnish that is ultraviolet curable, and applies the varnish to the sheet,
a UV irradiation unit that is capable of being disposed at a first position, and a second position that is on a downstream side in a conveying direction of the sheet from the first position and on an upstream side in the conveying direction from a position at which a transfer device is disposed, and that performs irradiation of the varnish that is applied by UV rays, and
the transfer device that executes predetermined transfer processing on the varnish irradiated by the UV rays,
   the sheet embellishing method including
determining at which of the first position and the second position the UV irradiation unit is situated, and
controlling the UV irradiation unit such that a total light intensity of UV rays by which the varnish is irradiated by the UV irradiation unit is smaller in a case in which the UV irradiation unit is determined to be situated at the first position as compared to a case in which the UV irradiation unit is determined to be situated at the second position.

Another aspect of the present invention is a non-transitory storage medium storing a machine-readable program,
the program being read by a computer installed in a sheet embellishing system that subjects a sheet to embellishment while conveying the sheet, the sheet embellishing system including
a varnish-discharging unit that discharges varnish that is ultraviolet curable, and applies the varnish to the sheet,
a UV irradiation unit that is capable of being disposed at a first position, and a second position that is on a downstream side in a conveying direction of the sheet from the first position and on an upstream side in the conveying direction from a position at which a transfer device is disposed, and that performs irradiation of the varnish that is applied by UV rays, and
the transfer device that executes predetermined transfer processing on the varnish irradiated by the UV rays,
   the program causing the computer to execute
determining at which of the first position and the second position the UV irradiation unit is situated, and
controlling the UV irradiation unit such that a total light intensity of UV rays by which the varnish is irradiated by the UV irradiation unit is smaller in a case in which the UV irradiation unit is determined to be situated at the first position as compared to a case in which the UV irradiation unit is determined to be situated at the second position.

A sheet embellishing system according to yet another aspect of the present disclosure is a sheet embellishing system that subjects a sheet to embellishment while conveying the sheet. The sheet embellishing system includes a varnish-discharging unit that discharges varnish that is ultraviolet curable, and applies the varnish to the sheet, a UV irradiation unit that performs irradiation of the varnish that is applied by UV rays, and a transfer device that executes predetermined transfer processing on the varnish irradiated by the UV rays by the UV irradiation unit. A first mode in which a varnish-coated region is formed by being coated with varnish alone, and a second mode in which a transfer region is formed by the transfer processing, can be executed by passing the sheet through the sheet embellishing system, and a total light intensity of UV rays by which the varnish is irradiated by the UV irradiation unit is smaller in a case in which the second mode is executed as compared to a case in which the first mode is executed.

It should be noted that optional combinations of the above components, and arrangements in which components and expressions of the present disclosure are interchanged among methods, devices, systems, and so forth, are also valid aspects of the present disclosure.

### BRIEF DESCRIPTION OF THE DRAWINGS

FIG. 1 is a side view schematically illustrating a sheet embellishing system according to an embodiment;

FIG. 2 is a top view schematically illustrating the sheet embellishing system according to the embodiment;

FIG. 3 is a functional block diagram of a control device according to the embodiment;

FIG. 4 is a functional block diagram of a control device according to a modification;

FIG. 5 is a top view of a varnish-applying device according to a modification;

FIG. 6 is a side view of the varnish-applying device according to the modification;

FIGS. 7A to 7C are side views illustrating principal portions of the varnish-applying device according to the modification; and

FIG. 8 is a top view illustrating a shielding plate according to the modification.

### DESCRIPTION OF THE PREFERRED EMBODIMENTS

The present disclosure will be described below by way of a preferred embodiment, with reference to the drawings. The embodiment does not limit the disclosure but rather is exemplary, and not all features and combinations thereof described in the embodiment are necessarily essential to the disclosure. Components, members, and processing that are the same or equivalent in the drawings are denoted by the same symbols, and repetitive description will be omitted as appropriate.

A conventional sheet embellishing system has both of an ultraviolet (UV) irradiation unit for full-curing of varnish-coated regions and a UV irradiation unit for half-curing of transfer regions. This has consequently led to high costs of the sheet embellishing system. Accordingly, from the perspective of cost reduction, there is demand for a sheet embellishing system in which functions of a light source for varnish coating and functions of a light source for half-curing can be handled by a single UV irradiation unit. On the other hand, varnish that is applied to a sheet bleeds as the sheet is being conveyed following the varnish being applied by a varnish-applying device, and gradually spreads in the planar direction of the sheet. Accordingly, in a case in which functions of a light source for varnish coating (full-curing) and functions of a light source for transfer processing (half-curing) are to be handled by a single UV irradiation unit, a position at which this UV irradiation unit is to be disposed is an issue.

In a case in which the UV irradiation unit happens to be disposed near the varnish-applying device, the varnish tends to be irradiated by UV rays before spreading, the amount of time from applying the varnish to starting of curing is shorter, and accordingly the varnish spreads less readily. In a case of using the UV irradiation unit for half-curing, the half-curing is performed in a state in which the varnish has not spread, which is advantageous in that foil stamping in a sharp form that is intended can be readily performed. On the other hand, in a case of using the UV irradiation unit for full-curing, the full-curing is performed before the varnish sufficiently spreads, which is disadvantageous in that spotty varnish readily occurs.

In a case in which the UV irradiation unit happens to be disposed at a position away from the varnish-applying device, the varnish tends to be irradiated by UV rays in a spread state, the amount of time from applying the varnish to starting of curing is longer, and accordingly the varnish spreads more readily. In a case of using the UV irradiation unit for full-curing, the full-curing tends to be performed in a state in which the varnish is sufficiently spread, which is advantageous in that spotty varnish does not readily occur. On the other hand, in a case of using the UV irradiation unit for half-curing, the half-curing tends to be performed in a state in which the varnish is spread, which is disadvantageous in that foil stamping in a sharp form that is intended is not readily performed, due to lines becoming broader than intended, and so forth.

In this way, there are disadvantages in accordance with the position at which the UV irradiation unit is disposed, with regard to cases of performing full-curing and cases of performing half-curing. Thus, embellishing sheets with high quality in both cases of performing full-curing and cases of performing half-curing has been difficult.

An embodiment of the present disclosure will be described in light of the foregoing.

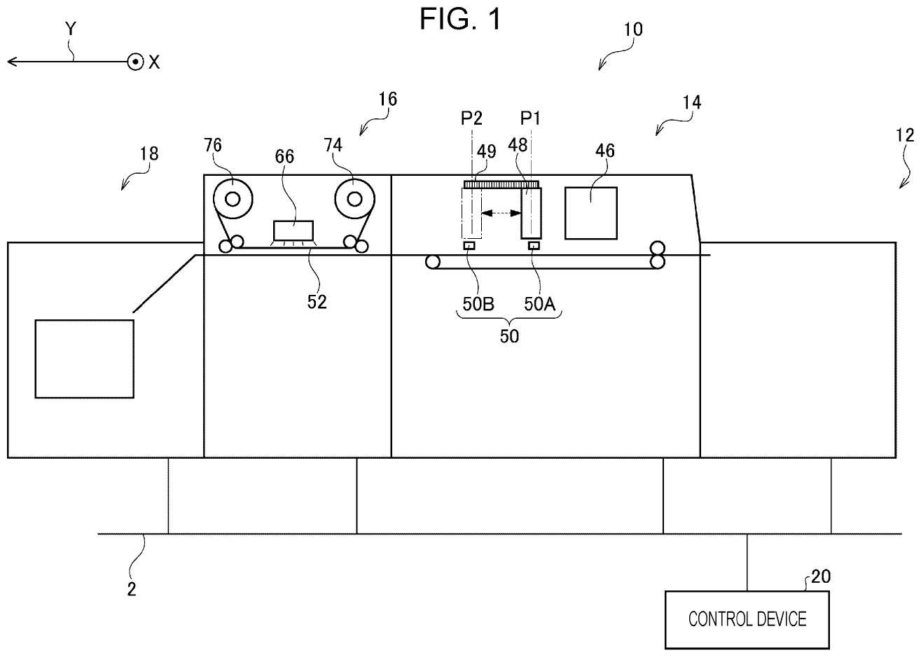

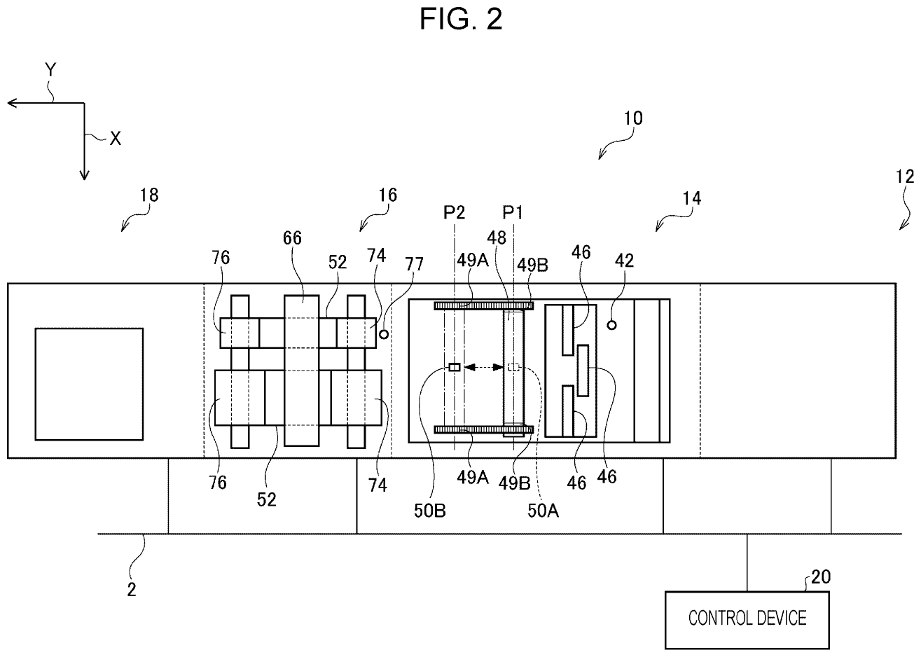

FIGS. 1 and 2 are diagrams that schematically illustrate a sheet embellishing system 10. FIG. 1 is a side view, and FIG. 2 is a top view. The sheet embellishing system 10 is a system that is capable of performing predetermined embellishment of sheets while conveying the sheets. The sheets are made of various materials, such as paper, textile, resin, metal, and so forth.

Hereinafter, a direction in which sheets are conveyed (direction from a sheet feeding device 12, which will be described later, toward a foil stamping device 16 in FIGS. 1 and 2) will be referred to as a conveying direction Y, and a lateral direction orthogonal to the conveying direction Y (direction orthogonal to the drawing in FIG. 1 and also a transverse direction to the sheet embellishing system 10 in FIG. 2) as a width direction X.

The sheet embellishing system 10 includes the sheet feeding device 12 that feeds sheets, one at a time, a varnish-applying device 14 that applies an ultraviolet (UV) curable varnish (hereinafter, also referred to simply as “varnish”) to the sheets that are fed thereto one at a time, and irradiates the varnish by UV rays, the foil stamping device 16 that transfers foil onto the varnish that is applied to the sheet taking advantage of tackiness of the varnish in a half-cured state, i.e., performs foil stamping, a stacker 18 that stacks the sheets, and a control device 20 that centrally controls the sheet embellishing system 10. The sheet feeding device 12, the varnish-applying device 14, the foil stamping device 16, and the stacker 18 are arrayed in a single row in this order, from an upstream side (sheet feeding device 12 side in FIGS. 1 and 2) toward a downstream side in the conveying direction Y. The control device 20 is connected to the sheet feeding device 12, the varnish-applying device 14, the foil stamping device 16, and the stacker 18, via a network 2.

In the present embodiment, the sheet embellishing system 10 is capable of executing a first mode (varnish-coating mode) in which varnish-coated regions are formed by passing sheets through this sheet embellishing system 10, and a second mode (transfer mode) in which transfer (foil stamping) regions are formed by passing sheets therethrough. The control device 20 may accept selection of which mode to execute from a user.

The sheet feeding device 12 feeds sheets loaded on a sheet loading unit to the varnish-applying device 14, one sheet at a time. The sheets have a base image, and a plurality of registration marks that serve as references for identifying a position of the base image, which are printed thereupon by an unshown printing device that is present at a physically removed location, for example.

The varnish-applying device 14 includes a sheet sensor 42, at least one (three in FIG. 2) varnish-discharging unit 46, and a UV irradiation unit 48. The sheet sensor 42, the varnish-discharging units 46, and the UV irradiation unit 48 are provided in this order from the upstream side toward the downstream side. The count of the varnish-discharging units 46 is not limited in particular. The varnish-applying device 14 may include one varnish-discharging unit 46 that extends over or beyond a range of the width direction X in which discharging of varnish is necessary, or may include two, or four or more, varnish-discharging units 46.

The sheet sensor 42 detects sheets fed from the sheet feeding device 12.

The varnish-discharging units 46 are line inkjet heads, although not limited thereto in particular. Under control of the control device 20, the varnish-discharging units 46 discharge varnish in accordance with varnish discharging data, triggered by detection of a sheet by the sheet sensor 42, and thereby apply varnish to the sheet. The varnish discharge data is data indicating regions of the sheet to which varnish is to be applied (hereinafter referred to as varnish-application regions). The varnish-application regions may have a predetermined relation with a base image.

The UV irradiation unit 48 emits UV rays under control of the control device 20. The UV irradiation unit 48 includes one or a plurality of UV light sources. UV light sources typically are light-emitting diodes (LEDs), but other light sources, such as light bulbs, fluorescent lamps, or the like may be used, as long as they are light sources that emit UV rays.

The varnish-applying device 14 further includes a moving mechanism 49 and a position sensor 50.

The moving mechanism 49 is configured to be capable of changing the position of the UV irradiation unit 48 between a first position P1 and a second position P2. The moving mechanism 49 is capable of moving the UV irradiation unit 48 between the first position P1 and the second position P2. The second position P2 is a position on the downstream side in the conveying direction Y of sheets from the first position P1, and is a position on the upstream side in the conveying direction Y from a position at which the foil stamping device 16 is disposed. The moving mechanism 49 according to the present embodiment includes a slide rail 49A that extends from the first position P1 to the second position P2, and a slider 49B that is provided on the UV irradiation unit 48 and that is capable of sliding movement along the slide rail 49A between the first position P1 and the second position P2. The slide rail 49A is provided on a main unit portion of the varnish-applying device 14, for example.

In the present embodiment, the user can use the moving mechanism 49 to manually move the UV irradiation unit 48 to the first position P1 or the second position P2, in accordance with the mode that is selected. For example, in a case of selecting the first mode, the user manually moves the UV irradiation unit 48 to the second position P2, using the moving mechanism 49. Also, for example, in a case of selecting the second mode, the user manually moves the UV irradiation unit 48 to the first position P1, using the moving mechanism 49.

The position sensor 50 senses that the UV irradiation unit 48 is situated at the first position P1 or the second position P2. The position sensor 50 includes a first position sensor 50A that senses that the UV irradiation unit 48 is at the first position P1, and a second position sensor 50B that senses that the UV irradiation unit 48 is at the second position P2. The position sensor 50 is, for example, a ranging sensor such as an infrared sensor or the like that measures a distance to the UV irradiation unit 48. The position sensor 50 is not limited to this, and may be an optical sensor or a mechanical switch that senses the presence or absence of the UV irradiation unit 48 at the first position P1 or the second position P2. In this case, when the UV irradiation unit 48 reaches the first position P1 or the second position P2, the UV irradiation unit 48 may be sensed as being situated at the first position P1 or the second position P2 in response to the presence thereof being sensed by this optical sensor or coming into contact with the mechanical switch.

Now, in the first mode, all varnish applied to the sheet is full-cured by the varnish being irradiated by UV rays from the UV irradiation unit 48 at the second position P2. Full-curing means that the varnish is completely cured. In the first mode, no foil stamping is performed at the foil stamping device 16 that is downstream. Accordingly, a foil-stamping UV irradiation unit 66 of the foil stamping device 16 is preferably off. In the first mode, embellishment of the sheet can be started after the user moves the UV irradiation unit 48 to the second position P2 using the moving mechanism 49, for example.

In the second mode, all varnish applied to the sheet is half-cured by the varnish being irradiated by UV rays from the UV irradiation unit 48 at the first position P1. Half-curing means curing to a degree where fluidity of the varnish is diminished but the varnish is not completely cured, to a state in which further curing can be performed, for example. Varnish in the half-cured state has tackiness. The half-cured varnish is subjected to foil-stamping and is also full-cured at the foil stamping device 16 downstream. In the second mode, embellishment of the sheet can be started after the user moves the UV irradiation unit 48 to the first position P1 using the moving mechanism 49, for example. Note that moving the UV irradiation unit 48 to the first position P1 or the second position P2 may be performed before accepting user input of a job definition, which will be described later, or after accepting user input of the job definition, as long as before starting embellishment of the sheet.

In the present embodiment, in a case in which the UV irradiation unit 48 is at the first position P1, UV irradiation intensity by the UV irradiation unit 48 is made to be smaller than in a case in which the UV irradiation unit 48 is at the second position P2. For example, the UV irradiation intensity of the UV irradiation unit 48 in a case of being situated at the first position P1 is 6 W/cm², and the UV irradiation intensity of the UV irradiation unit 48 in a case of being situated at the second position P2 is 256 W/cm².

In the first mode, the foil stamping device 16 conveys the sheet to the stacker 18 as it is. That is to say, in the first mode, the foil stamping device 16 does not perform foil stamping.

In the second mode, the foil stamping device 16 conveys the sheet, and also conveys a web (transfer web) 52 by roll-to-roll, and transfers foil borne by the web 52 onto the sheet, i.e., performs foil-stamping. The web 52 is a foil-bearing film that bears foil (e.g., metal foil) on a film (base sheet). The foil stamping device 16 causes the foil borne by the web 52 to adhere to the varnish, using the tackiness of the varnish in the half-cured state. In this state in which the foil adheres to the varnish in the half-cured state, while being borne by the web 52, the foil-stamping UV irradiation unit 66 irradiates the varnish in the half-cured state by UV rays, thereby performing full-curing of the varnish. Once the varnish is full-cured, the force of the foil adhering to the varnish is greater than the force of the web 52 bearing the foil. Separating the web 52 from the sheet in this state transfers the foil that was borne by the web 52 to the varnish on the sheet. The foil stamping device 16 according to the present embodiment is an example of a transfer device.

The stacker 18 stacks sheets (embellished sheets) that are carried out from the foil stamping device 16.

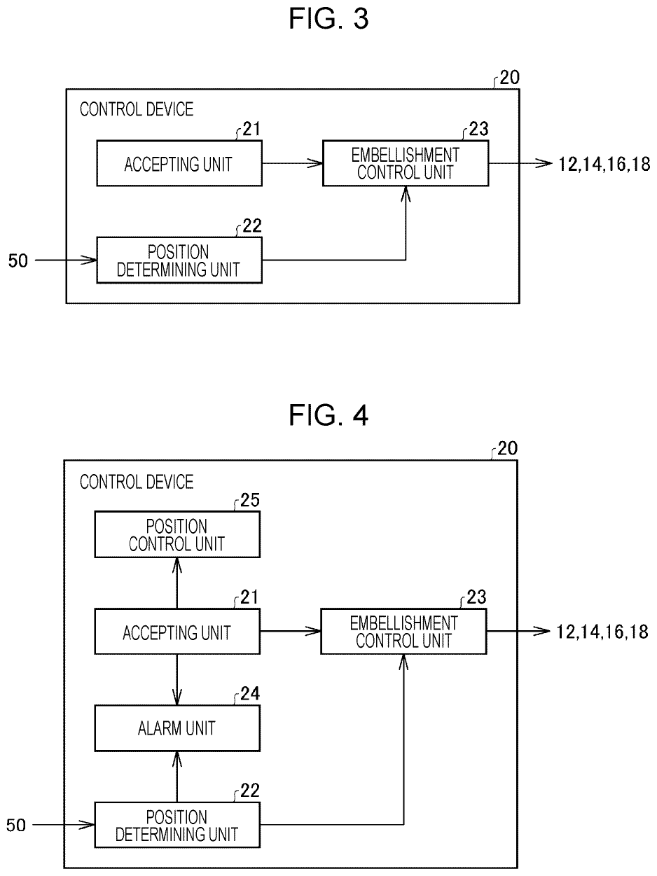

The control device 20 controls overall operations of the sheet embellishing system 10. FIG. 3 is a functional block diagram illustrating the control device 20 according to the embodiment. As illustrated in FIG. 3, the control device 20 includes an accepting unit 21, a position determining unit 22, and an embellishment control unit 23. The control device 20 can be realized hardwarewise by devices such as processors like a central processing unit (CPU) or the like and memory like read-only memory (ROM) and random access memory (RAM) and so forth of a computer, and mechanical devices, and can be realized softwarewise by computer programs and so forth. Accordingly, one skilled in the art will appreciate that the control device 20 can be realized in various forms through combinations of hardware and software.

The accepting unit 21 accepts user input regarding the job definitions of sheet embellishment. The accepting unit 21 may accept user information regarding the job definitions via a predetermined job management screen that is displayed on an unshown display screen. Examples of job definitions can include a count of sheets to be embellished (embellishment count), sheet size, varnish discharge data, and mode to be executed. That is to say, the accepting unit 21 can accept first user input for selecting the first mode, and second user input for selecting the second mode.

The position determining unit 22 determines at which position of the first position P1 and the second position P2 that the UV irradiation unit 48 is situated. The position determining unit 22 according to the present embodiment determines at which position of the first position P1 and the second position P2 that the UV irradiation unit 48 is situated, on the basis of sensing results by the position sensor 50. The position determining unit 22 supplies determination results of position regarding the UV irradiation unit 48 to the embellishment control unit 23.

The embellishment control unit 23 controls the sheet feeding device 12, the varnish-applying device 14, and the foil stamping device 16, on the basis of the job definitions. The embellishment control unit 23 according to the present embodiment sets the UV irradiation intensity of the UV irradiation unit 48 on the basis of determination results of the position of the UV irradiation unit 48 by the position determining unit 22. Specifically, the embellishment control unit 23 according to the present embodiment controls the UV irradiation unit 48 such that in a case in which the UV irradiation unit 48 is determined to be situated at the first position P1, total light intensity of UV rays by which the varnish is irradiated is made to be smaller than a case in which the UV irradiation unit 48 is determined to be situated at the second position P2. For example, on the basis of determination results to the effect that the UV irradiation unit 48 is situated at the first position P1, the UV irradiation intensity of the UV irradiation unit 48 is set to 6 W/cm². Also, for example, on the basis of determination results to the effect that the UV irradiation unit 48 is situated at the second position P2, the UV irradiation intensity of the UV irradiation unit 48 is set to 256 W/cm².

The control device 20 controls operations of each of the devices of the sheet embellishing system 10 in accordance with a program stored in memory, for example, by a processor executing the program. The processor may execute a program stored in a storage device, may execute a program acquired by a reading device from a non-transitory storage medium storing the program, or may execute a program acquired by a communication interface via a network.

The program that the control device 20 executes can execute the first mode and the second mode. For example, a program stored in a storage device in advance may be capable of executing the first mode and the second mode. Alternatively, a program that is capable of executing the first mode and the second mode may be stored in a storage device subsequently.

Now, when the total light intensity (J/cm²) of UV rays by which the varnish is irradiated at the first position P1 in the second mode is too great, the varnish will be full-cured, and when the total light intensity of UV rays by which the varnish is irradiated is too small, the varnish cannot be half-cured. When the total light intensity of UV rays by which the varnish is irradiated at the second position P2 in the first mode is too small, the varnish cannot be full-cured.

The higher the UV ray intensity of the UV rays by which the varnish is irradiated, and also the longer the time over which the varnish is irradiated by UV rays is, the greater the total light intensity of UV rays is. Also, the lower the UV ray intensity of the UV rays by which the varnish is irradiated, and also the shorter the time over which the varnish is irradiated by UV rays is, the smaller the total light intensity of UV rays is.

Accordingly, there is a need to appropriately decide irradiation conditions by UV rays, which are conditions that affect the total light intensity. The irradiation conditions by UV rays include at least UV irradiation intensity, UV irradiation range, UV emission distance, and sheet conveying speed.

The “UV irradiation intensity” is the UV ray intensity of UV rays emitted by the UV irradiation unit 48. The higher the UV irradiation intensity is, the higher the UV ray intensity of UV rays by which the varnish is irradiated is, and the lower the UV irradiation intensity is, the lower the UV ray intensity of UV rays by which the varnish is irradiated is.

The “UV irradiation range” is an irradiation range of UV rays emitted by the UV irradiation unit 48. The broader the UV irradiation range is, the longer the UV irradiation range is in the conveying direction Y. Accordingly, the broader the UV irradiation range is, the longer the irradiation time by UV rays is regarding a point on the sheet being conveyed at a predetermined conveying speed, to pass through the UV irradiation range. The narrower the UV irradiation range is, the shorter the UV irradiation range is in the conveying direction Y. Accordingly, the narrower the UV irradiation range is, the shorter the irradiation time by UV rays is regarding a point on the sheet being conveyed at the predetermined conveying speed, to pass through the UV irradiation range.

The “UV emission distance” is a distance (height) from the UV irradiation unit 48 to the sheet that it faces. The shorter the UV emission distance is, the higher the UV ray intensity of UV rays by which the varnish is irradiated is, and the longer the UV emission distance is, the lower the UV ray intensity of UV rays by which the varnish is irradiated is. Also, the UV rays emitted by the UV irradiation unit 48 spread, and accordingly the longer the UV emission distance is, the broader the UV irradiation range is. On the other hand, the shorter the UV emission distance is, the narrower the UV irradiation range is.

The “sheet conveying speed” is the conveying speed of conveying sheets. The slower the sheet conveying speed is, the longer the irradiation time by UV rays is, and the faster the sheet conveying speed is, the shorter the irradiation time by UV rays is.

It is sufficient for the user to decide the irradiation conditions by UV rays with respect to the varnish at the second position P2 in the first mode, and the irradiation conditions by UV rays with respect to the varnish at the first position P1 in the second mode, on the basis of testing and simulation. Note that varnish that is to be full-cured needs a greater total light intensity than varnish that is to be half-cured, and accordingly, the irradiation conditions for the varnish at the first position P1 differ from the irradiation conditions for the varnish at the second position P2, as a matter of course. It is sufficient for the irradiation conditions to be decided for each of the first position P1 and the second position P2 such that, for example, the total light intensity of UV rays by which the varnish is irradiated is smaller in a case in which the UV irradiation unit 48 is situated at the first position P1, as compared to a case in which the UV irradiation unit 48 is situated at the second position P2.

Also, the degree of spreading of the varnish on the sheet when the sheet arrives at the first position P1 or at the second position P2 changes in accordance with irradiation conditions of UV rays, such as sheet conveying speed and so forth, and the positions where the first position P1 and the second position P2 are set. Accordingly, it is sufficient for the user to decide the first position P1 and the second position P2 on the basis of testing and simulation.

Next, advantageous effects of the present embodiment will be described. According to the present embodiment, the UV irradiation unit 48 can be disposed at the first position P1 and at the second position P2, and adjustment is performed such that the total light intensity of UV rays by which the varnish is irradiated by the UV irradiation unit 48 is smaller in a case in which the UV irradiation unit 48 is situated at the first position as compared to a case in which the UV irradiation unit 48 is situated at the second position. Thus, the position and the total light intensity can be adjusted in accordance with the usage of full-curing or half-curing. Accordingly, spotty varnish can be suppressed in a case of performing full-curing, and foil stamping can be readily performed on sharp shapes in a case of performing half-curing. Accordingly, even in a case of a single UV irradiation unit 48 handling both the light source for full-curing and the light source for half-curing from the perspective of reducing costs, the sheet can be embellished with high quality in both of a case of performing full-curing and a case of performing half-curing.

The present disclosure has been described above by way of the embodiment. This embodiment is exemplary, and it will be appreciated by those skilled in the art that various modification can be made in combinations of the components thereof and the processing processes, and that such modifications fall within the scope of the present disclosure. Such modifications will be described below.

### Modifications

In place of the sheet feeding device 12, a printing device may be provided that prints images on sheets and feeds the sheets to the varnish-applying device 14 one sheet at a time.

Also, the sheet embellishing system 10 may be provided with another device between the foil stamping device 16 and the stacker 18. The other device may be, for example, a post-processing device that cuts and binds sheets, a separate applying device for protecting the foil surface with varnish, an interleaving sheet inserter for surface protection purposes, a puncher for punching sheets into predetermined shapes for creating carton materials or the like, and a post-processing device for surface protection purposes by interleaving sheets or the like.

FIG. 4 is a functional block diagram of the control device 20 according to a modification. As illustrated in FIG. 4, the control device 20 may include an alarm unit 24. For example, the alarm unit 24 issues a predetermined warning in at least one case of a case in which the accepting unit 21 has accepted the first user input of selecting the first mode but the UV irradiation unit 48 is not sensed as being situated at the second position P2 by the position sensor 50, and a case in which the accepting unit 21 has accepted the second user input of selecting the second mode but the UV irradiation unit 48 is not sensed as being situated at the first position P1 by the position sensor 50. The warning here is outputting, by display or audio, a message such as, “the UV irradiation unit is not at the proper position” or the like, turning a lamp on, outputting a buzzer sound, or the like. The timing of issuing the warning is, for example, when user input for starting embellishment of sheets is accepted by the accepting unit 21. In this case, the warning is issued, and embellishment of sheets does not need to be started until the position sensor 50 senses that the UV irradiation unit 48 is disposed in a proper position thereof. According to this configuration, a situation in which the first mode or the second mode is executed regardless of the UV irradiation unit 48 not being disposed in the proper position thereof, can be suppressed.

Also, as illustrated in FIG. 4, the control device 20 may include a position control unit 25. The position control unit 25 controls the moving mechanism 49 so as to move the UV irradiation unit 48 to the second position P2 in a case in which the accepting unit 21 accepts the first user input selecting the first mode, and to move the UV irradiation unit 48 to the first position P1 in a case in which the accepting unit 21 accepts the second user input selecting the second mode. For example, the position control unit 25 drives an unshown actuator to apply weight to the UV irradiation unit 48 in the conveying direction Y, thereby causing the UV irradiation unit 48 to move by sliding over the slide rail 49A by way of the slider 49B attached to the UV irradiation unit 48. According to this configuration, the trouble of the user manually moving the UV irradiation unit 48 to the first position P1 or the second position P2 can be eliminated.

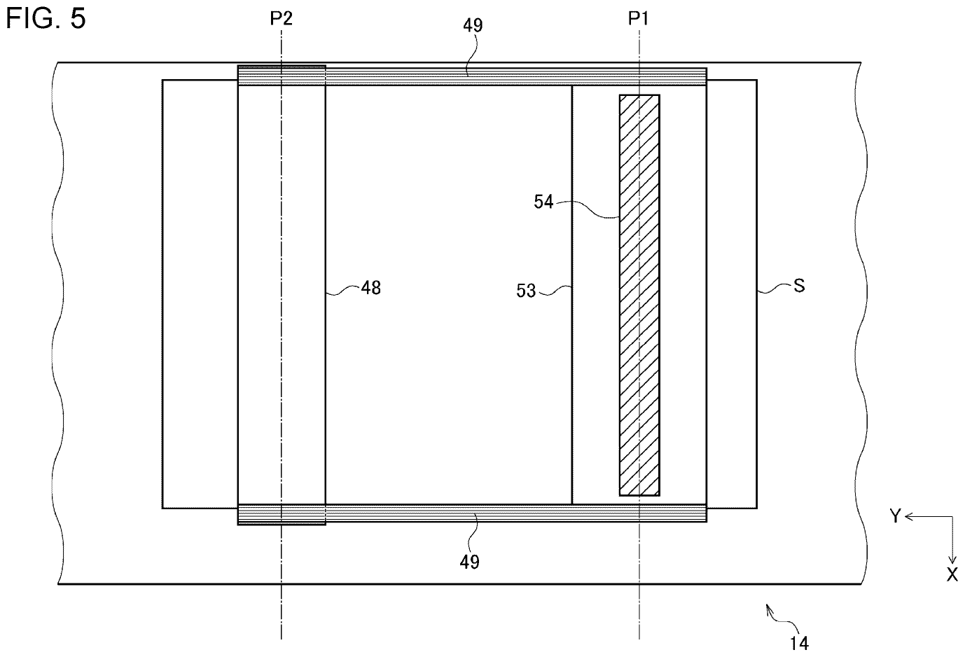

FIG. 5 is a top view of a varnish-applying device according to a modification. FIG. 5 exemplifies a case in which the UV irradiation unit 48 is situated at the second position P2. As illustrated in FIG. 5, a shielding plate 53 having a slit 54 may be provided at the first position P1. Now, in a conventional arrangement having two UV irradiation units, one for full-curing and one for half-curing, the UV irradiation range of the UV irradiation unit for half-curing that is disposed at the first position P1 is often set to be narrower than the UV irradiation range of the UV irradiation unit for full-curing that is disposed at the second position P2, from a perspective of optimizing UV irradiation range between that for full-curing and that for half-curing. In comparison with this, disposing the shielding plate 53 at the first position P1 enables UV rays emitted from the UV irradiation unit 48 to be shielded by the shielding plate 53, except for those passing through the slit 54, when the UV irradiation unit 48 is disposed at the first position P1. Accordingly, the UV irradiation range of the UV irradiation unit 48 can be optimized as a narrow range with a simple configuration. Also, the total light intensity of UV rays in a case in which the UV irradiation unit 48 is situated at the first position P1 can be reduced by a simple configuration. Note that the shielding plate 53 does not need to have the slit 54, as long as the UV irradiation range of the UV irradiation unit 48 can be narrowed.

In the present embodiment, the position determining unit 22 determines the position of the UV irradiation unit 48 on the basis of sensing results of the position sensor 50 but is not limited to this. For example, the position determining unit 22 may determine the position of the UV irradiation unit 48 on the basis of user input regarding the mode to be executed that the accepting unit 21 has accepted. For example, in a case in which the accepting unit 21 accepts user input selecting the first mode, the position determining unit 22 may determine that the UV irradiation unit 48 is situated at the second position P2. Also, in a case in which the accepting unit 21 accepts user input selecting the second mode, for example, the position determining unit 22 may determine that the UV irradiation unit 48 is situated at the first position P1.

While the sheet embellishing system 10 has been described as having the moving mechanism 49 in the embodiment, this is not restrictive. For example, the sheet embellishing system 10 may have connecting members or the like that are disposed at the first position P1 and the second position P2 of the main unit of the varnish-applying device 14, to which the UV irradiation unit 48 can be detachably attached.

While the moving mechanism 49 has been described as including the slide rail 49A and the slider 49B in the embodiment, this is not restrictive. For example, the moving mechanism 49 may be a mechanical arm or the like that is attached to the UV irradiation unit 48 and that can move the UV irradiation unit 48 to each of the first position P1 and the second position P2.

Thickness of varnish affects full-curing and half-curing of the varnish, although this point is not mentioned in the embodiment in particular. Accordingly, irradiation conditions may be adjusted taking the thickness of varnish into consideration. For example, irradiation may be performed such that the thicker the varnish is, the stronger the UV ray intensity of UV rays used for irradiation is, and the thinner the varnish is, the weaker the UV ray intensity of UV rays used for irradiation is.

While a case of performing foil stamping on half-cured varnish, i.e., a case of performing foil stamping as transfer processing, has been described in the embodiment and the above modification, this is not restrictive, and other transfer processing may be executed on the half-cured varnish. For example, instead of the foil stamping device 16, a transfer device may be provided that executes transfer processing, in which a web with fine asperities formed on the surface thereof is brought into close contact with the half-cured varnish, so as to transfer the features of the fine asperities to the varnish.

While the total light intensity at the first position and the second position has been described as being adjusted by the embellishment control unit 23 adjusting the UV irradiation intensity of the UV irradiation unit 48 in the embodiment, this is not restrictive. The embellishment control unit 23 may adjust the total light intensity at the first position and the second position by adjusting the UV irradiation range, the UV emission distance, and the sheet conveying speed.

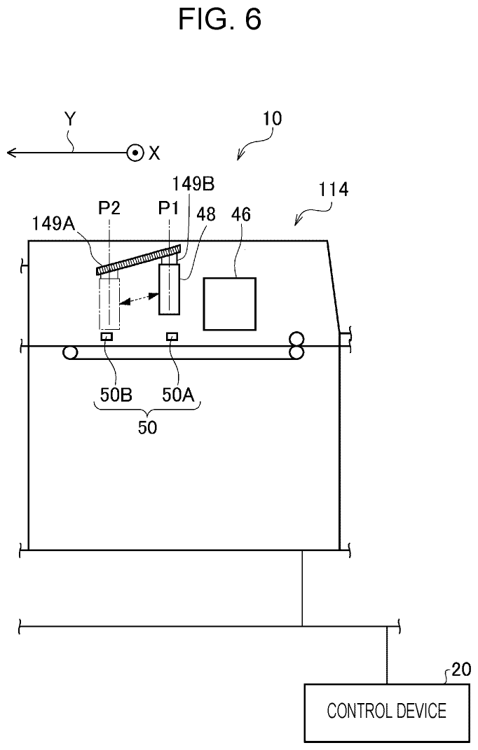

For example, a configuration may be made such that the UV emission distance is longer when the UV irradiation unit 48 is situated at the first position P1, as compared to when the UV irradiation unit 48 is situated at the second position P2. FIG. 6 is a side view of a varnish-applying device according to the present modification. As illustrated in FIG. 6, a varnish-applying device 114 according to the present modification is configured such that a position of the UV irradiation unit 48 in a height direction (direction orthogonal to both the conveying direction Y and the width direction X) is higher when the UV irradiation unit 48 is situated at the first position P1 as compared to when the UV irradiation unit 48 is situated at the second position P2. A slide rail 149A that inclines upward from the second position P2 to the first position P1 is provided. The UV irradiation unit 48 is configured so as to be capable of moving along the slide rail 149A by way of a slider 149B. Accordingly, as the UV irradiation unit 48 moves from the second position P2 to the first position P1, the height of the UV irradiation unit 48 increases. The higher the UV irradiation unit 48 is situated, the longer the distance is for the UV rays to reach the sheet, and the UV rays are spread and attenuated accordingly. Accordingly, in a case in which the UV irradiation unit 48 is situated at the first position P1, the UV irradiation intensity per region to be full-cured or half-cured is smaller than in a case of the UV irradiation unit 48 being situated at the second position P2. Consequently, the total light intensity is smaller.

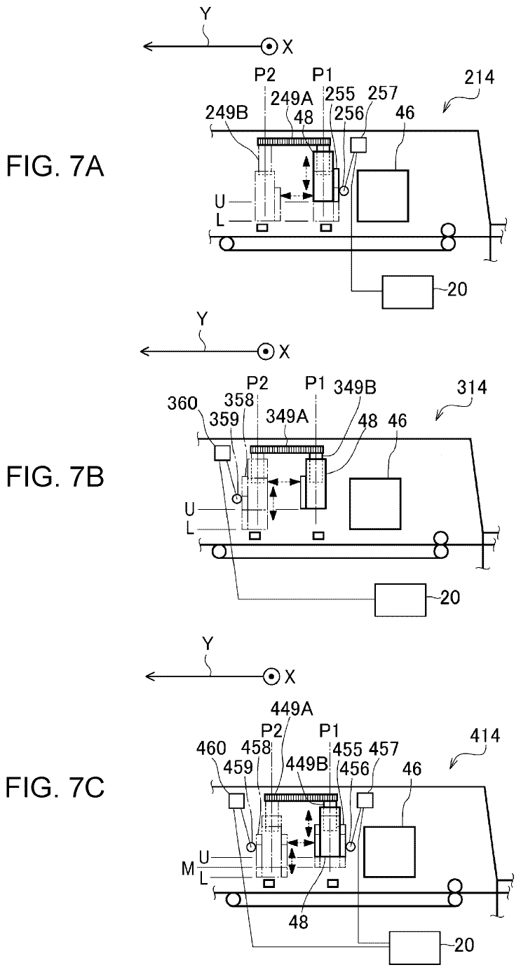

A lift mechanism for raising and lowering the UV irradiation unit 48 may be provided at one of the first position P1 and the second position P2, to raise or lower the UV irradiation unit 48, such that the height of the UV irradiation unit 48 in a case of being situated at the first position P1 is higher than in a case of being situated at the second position P2. FIGS. 7A to 7C are side views illustrating principal portions of a varnish-applying device according to the present modification. A varnish-applying device 214 illustrated in FIG. 7A is configured such that when the UV irradiation unit 48 is situated at a lower position (position at which a lower face of the UV irradiation unit 48 matches a lower position line L), the UV irradiation unit 48 is capable of moving between the first position P1 and the second position P2 along a slide rail 249A by way of a slider 249B. Further, when the UV irradiation unit 48 is situated at the first position P1, the UV irradiation unit 48 can be raised from the lower position to an upper position (position at which the lower face of the UV irradiation unit 48 matches an upper position line U). A configuration is made such that when the UV irradiation unit 48 moves to the first position P1, a rack 255 provided to the UV irradiation unit 48 meshes with a pinion gear 256 that is fixedly disposed. The UV irradiation unit 48 is raised and lowered by driving the pinion gear 256 by a motor 257. Driving control of the motor 257 is performed by the control device 20. When situated at the second position P2, the UV irradiation unit 48 is at the lower position, and when situated at the first position P1, the UV irradiation unit 48 is raised to the upper position, such that the height of the UV irradiation unit 48 situated at the first position P1 is higher than in a case of the UV irradiation unit 48 being situated at the second position P2.

In the example in FIG. 7A, the control device 20 may be capable of adjusting the height (amount of raising) the UV irradiation unit 48 at the first position P1, such that the total light intensity of UV rays is appropriate for the degree of spreading of the varnish that differs in accordance with various conditions, such as type of the sheets and base images on the sheets, temperature of the sheets, ambient temperature and humidity, whether or not corona treatment is performed prior to application of varnish, and so forth. This adjustment is realized by the control device 20 adjusting the rotational amount of the pinion gear 256 in accordance with the various conditions. Thus, half-curing of varnish by the UV irradiation unit 48 situated at the first position P1 can be made to be appropriate under the various conditions.

A varnish-applying device 314 illustrated in FIG. 7B is configured such that the UV irradiation unit 48, when situated at the upper position, is capable of moving between the first position P1 and the second position P2 along a slide rail 349A by way of a slider 349B. Further, when situated at the second position P2, the UV irradiation unit 48 can be lowered from the upper position to the lower position. A configuration is made such that when the UV irradiation unit 48 moves to the second position P2, a rack 358 provided to the UV irradiation unit 48 meshes with a pinion gear 359 that is fixedly disposed. The UV irradiation unit 48 is raised and lowered by driving the pinion gear 359 by a motor 360. Driving control of the motor 360 is performed by the control device 20. When situated at the first position P1, the UV irradiation unit 48 is at the upper position, and when situated at the second position P2, the UV irradiation unit 48 is lowered to the lower position, such that the height of the UV irradiation unit 48 situated at the first position P1 is higher than in a case of the UV irradiation unit 48 being situated at the second position P2.

In the example in FIG. 7B as well, the control device 20 may be capable of adjusting the height (amount of lowering) the UV irradiation unit 48 situated at the second position, on the basis of the above various conditions. This adjustment can be realized by the control device 20 adjusting the rotational amount of the pinion gear 359 in accordance with the various conditions. Thus, full-curing of varnish by the UV irradiation unit 48 situated at the second position P2 can be made to be appropriate under the various conditions.

A varnish-applying device 414 illustrated in FIG. 7C is configured such that the UV irradiation unit 48, when situated at a middle position that is intermediate between the upper position and the lower position (position at which the lower face of the UV irradiation unit 48 matches a middle position line M), is capable of moving between the first position P1 and the second position P2 along a slide rail 449A by way of a slider 449B. Further, when situated at the first position P1, the UV irradiation unit 48 can be raised from the middle position to the upper position, and also when situated at the second position P2, the UV irradiation unit 48 can be lowered from the middle position to the lower position. A configuration is made such that when the UV irradiation unit 48 moves to the first position P1, a rack 455 provided to the UV irradiation unit 48 meshes with a pinion gear 456 that is fixedly disposed, and also when the UV irradiation unit 48 moves to the second position P2, a rack 458 provided to the UV irradiation unit 48 meshes with a pinion gear 459 that is fixedly disposed. Driving the pinion gear 456 by a motor 457 raises and lowers the UV irradiation unit 48 that is situated at the first position P1, and also driving the pinion gear 459 by a motor 460 raises and lowers the UV irradiation unit 48 that is situated at the second position P2. Driving control of the motors 457 and 460 is performed by the control device 20. When situated at the first position P1, the UV irradiation unit 48 is raised to the upper position, and when situated at the second position P2 is lowered to the lower position, such that the height of the UV irradiation unit 48 situated at the first position P1 is higher than in a case of the UV irradiation unit 48 being situated at the second position P2.

In the example in FIG. 7C as well, the control device 20 may be capable of adjusting the height (amount of raising) the UV irradiation unit 48 situated at the first position P1, and the height (amount of lowering) the UV irradiation unit 48 situated at the second position P2, on the basis of the above various conditions. This adjustment can be realized by the control device 20 adjusting the rotational amount of the pinion gears 456 and 459 under the above various conditions. Thus, half-curing of varnish by the UV irradiation unit 48 situated at the first position P1, and full-curing of varnish by the UV irradiation unit 48 situated at the second position P2, can be made to be appropriate under the various conditions.

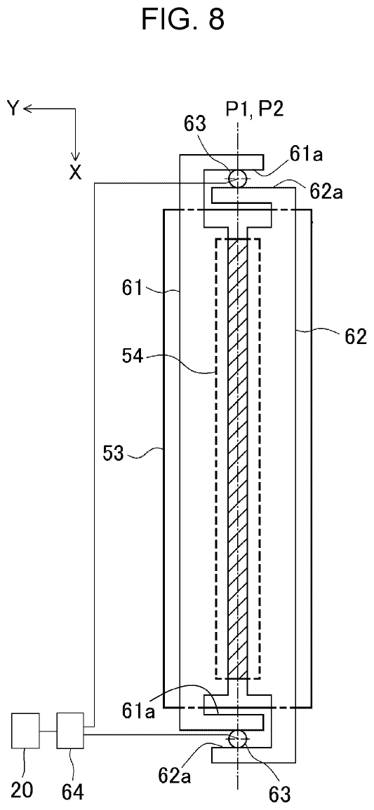

Also, the control device 20 may be capable of changing the width of the slit 54 of the shielding plate 53 described above. Accordingly, the total light intensity can be adjusted by adjusting the width of the slit 54. FIG. 8 is a top view illustrating the shielding plate 53 according to the present modification. In the present modification, adjustment plates 61 and 62 are provided on both sides of the slit 54 in the conveying direction Y. Pinion gears 63 are provided on both sides of the adjustment plates 61 and 62 in the width direction X, on a center line of the slit 54 in the conveying direction Y, and mesh with rack portions 61a and 62a extending from the adjustment plates 61 and 62 to both sides in the width direction X so as to be interposed therebetween in the width direction X. Rotation of the pinion gears 63 cause the adjustment plates 61 and 62 to move in directions toward each other or away from each other, and the width of the slit 54 in the conveying direction Y is adjusted. The pinion gears 63 both are driven by a motor 64 in the same direction. The control device 20 controls the motor 64, such that positions of the adjustment plates 61 and 62 can be adjusted. The shielding plate 53 is configured such that even in a case in which the slit 54 is adjusted such that the width thereof in the conveying direction Y is greatest, the width thereof is smaller than the width of the UV irradiation unit 48 in the conveying direction Y. Accordingly, providing the shielding plate 53 illustrated in FIG. 8 at the first position P1 makes the total light intensity to be smaller when the UV irradiation unit 48 is situated at the first position P1 as compared to when situated at the second position P2 where there is no shielding plate 53. The control device 20 may adjust the width of the slit 54 such that the total light intensity of UV rays is appropriate for the degree of spreading of the varnish that differs in accordance with various conditions, such as type of the sheets and base images on the sheets, temperature of the sheets, ambient temperature and humidity, whether or not corona treatment is performed prior to application of varnish, and so forth.

The shielding plate 53 described above may be provided at the second position P2 as well, such that the width of the slit 54 can be adjusted at the second position P2 as well, thereby enabling adjusting on the basis of the above various conditions in the first mode as well. In this case, the control device 20 controls the width of the slit 54 at the first position P1 so as to be smaller than the width of the slit 54 at the second position P2. The width of the slit 54 can be adjusted at both the first position P1 and the second position P2, and accordingly adjustment that is more appropriate in accordance with the various conditions can be performed.

Also, the shielding plate 53 described above may be fixed to a lower part of the UV irradiation unit 48, so as to be movable between the first position P1 and the second position P2 along with the UV irradiation unit 48. In this case, the control device 20 performs control such that the width of the slit 54 is smaller when the UV irradiation unit 48 is situated at the first position P1 as compared to when the UV irradiation unit 48 is situated at the second position P2. Accordingly, the total light intensity is smaller when the UV irradiation unit 48 is situated at the first position P1, as compared to when situated at the second position P2. In this case, the width of the slit 54 can be adjusted at both the first position P1 and the second position P2, enabling appropriate adjustment in accordance with various conditions, and also device costs can be reduced since only one shielding plate 53 having a width adjusting mechanism of the slit 54 is necessary.

The methods exemplified above may be combined, as a method for making the total light intensity to be smaller in case in which the UV irradiation unit 48 is situated at the first position P1, as compared to a case of being situated at the second position P2. That is to say, two methods, or all three methods, of adjusting the UV irradiation intensity by the UV irradiation unit 48, adjusting the slit width of the shielding plate at the first position P1 or the second position P2, or both positions, and adjusting the height of the UV irradiation unit 48 at the first position P1 or the second position P2, or both positions, may be combined. Combining these enables various conditions, such as type of the sheets and base images on the sheets, temperature of the sheets, ambient temperature and humidity, whether or not corona treatment is performed prior to application of varnish, and so forth, to be appropriately handled over a wider range.

While the moving mechanism 49 has been described in the embodiment as being configured to be capable of positioning the UV irradiation unit 48 at either one of the first position P1 and the second position P2 decided in advance, this is not restrictive. The second position P2 may be adjustable between the downstream side from the first position P1 and the upstream side from the position where the foil stamping device 16 is disposed. For example, in the first mode, the user may use the moving mechanism 49 to position the UV irradiation unit 48 at any position between the downstream side from the first position P1 and the upstream side from the position where the foil stamping device 16 is disposed, as the second position P2. The varnish applied to the sheet by the varnish-discharging unit 46 has fluidity before full-curing, and accordingly the varnish spreads in the planar direction of the sheet until the time of full-curing, and the degree of this spreading differs depending on various conditions such as type of the sheets and base images on the sheets, temperature of the sheets, ambient temperature and humidity, whether or not corona treatment is performed prior to application of varnish, and so forth. The longer the distance from the position of the varnish-discharging unit 46 to the second position P2 is, the longer the time is from application of varnish to full-curing, and the varnish spreads more readily in accordance therewith. Spreading of varnish in the varnish-application regions can be stabilized by the user setting the second position P2 to a position in accordance with the various conditions. Also, the position control unit 25 may be made to move the UV irradiation unit 48 to the second position P2 in accordance with the above various conditions when the user selects the first mode. The position control unit 25 may store part or all of the above various conditions in advance, or be capable of detection thereof, and set an appropriate position for the second position P2 in accordance therewith.

While the UV irradiation unit 48 has been described in the embodiment as being configured to be situated at either one of the first position P1 and the second position P2, this is not restrictive. The UV irradiation unit 48 may be fixedly situated at any one position between the downstream side from the varnish-discharging unit 46 and the upstream side from the position where the foil stamping device 16 is disposed, and the total light intensity by which the varnish applied to the sheet is irradiated by the UV irradiation unit 48 may be smaller in a case in which the second mode is executed, as compared to a case in which the first mode is executed. In a case of executing transfer processing on the varnish, such as foil stamping or the like, executing before the applied varnish spreads very much yields a sharp finish following transfer. On the other hand, in a case of executing creation processing of varnish-coated regions where coating by varnish alone is performed, a certain level of spreading is desirable, such that the varnish-coated regions will be fully coated to the edges thereof. There are cases in which varnish-coated regions with a sufficient range in the first mode, and a sharp finish in the second mode, can both be realized by changing just the total light intensity without changing the position of the UV irradiation unit 48, in accordance with parameters such as composition of the varnish and the sheets that are used, the type of base images on the sheets (printer that was used and so forth), amount of varnish that is applied, and so forth. In such cases, varnish-coated regions with a sufficient range, and embellishment with a sharp finish, can both be realized simply by setting the first mode and the second mode appropriately, and adjusting the total light intensity of the UV irradiation unit 48 of which the position is fixed.

Optional combinations of the above-described embodiment and Modifications are also valid embodiments of the present disclosure. New embodiments generated through combination have the advantages of both of the embodiment and the Modifications that are combined.

Generalizing the above-described embodiment and Modifications yields the following Aspects.

### [Aspect 1]

A sheet embellishing system that subjects a sheet to embellishment while conveying the sheet, the sheet embellishing system including:
a varnish-discharging unit that discharges varnish that is ultraviolet (UV) curable, and applies the varnish to the sheet;
a UV irradiation unit that is capable of being disposed at a first position, and a second position that is on a downstream side in a conveying direction of the sheet from the first position and on an upstream side in the conveying direction from a position at which a transfer device is disposed, and that performs irradiation of the varnish that is applied by UV rays;
the transfer device that executes predetermined transfer processing on the varnish irradiated by the UV rays; and
a position determining unit that determines at which of the first position and the second position the UV irradiation unit is situated, wherein
a total light intensity of UV rays by which the varnish is irradiated by the UV irradiation unit is smaller in a case in which the UV irradiation unit is determined to be situated at the first position as compared to a case in which the UV irradiation unit is determined to be situated at the second position.

### [Aspect 2]

The sheet embellishing system according to Aspect 1, further including:
a moving mechanism that is configured to be capable of changing a position of the UV irradiation unit between the first position and the second position.

### [Aspect 3]

The sheet embellishing system according to Aspect 2, wherein
the moving mechanism includes
   a slide rail that extends from the first position to the second position, and
   a slider that is provided on the UV irradiation unit and that is slidably movable between the first position and the second position following the slide rail.

### [Aspect 4]

The sheet embellishing system according to Aspect 2 or 3, further including:
an accepting unit that accepts a first user input for selecting a first mode in which the UV irradiation unit emits UV rays to perform full-curing of the varnish at the second position, and a second user input for selecting a second mode in which the UV irradiation unit emits UV rays to perform half-curing of the varnish at the first position; and
a position control unit that controls the moving mechanism to move the UV irradiation unit to the second position in a case of accepting the first user input, and to move the UV irradiation unit to the first position in a case of accepting the second user input.

### [Aspect 5]

The sheet embellishing system according to any one of Aspects 1 to 3, wherein
the position determining unit determines at which of the first position and the second position the UV irradiation unit is situated, on the basis of a sensing result of a position sensor that senses that the UV irradiation unit is situated at the first position and the second position.

### [Aspect 6]

The sheet embellishing system according to Aspect 5, further including:
an accepting unit that accepts a first user input for selecting a first mode in which the UV irradiation unit emits UV rays to perform full-curing of the varnish at the second position, and a second user input for selecting a second mode in which the UV irradiation unit emits UV rays to perform half-curing of the varnish at the first position; and
an alarm unit that issues a predetermined warning in at least one case of a case in which the first user input is accepted but the UV irradiation unit is not sensed by the position sensor as being situated at the second position, and a case in which the second user input is accepted but the UV irradiation unit is not sensed by the position sensor as being situated at the first position.

### [Aspect 7]

The sheet embellishing system according to any one of Aspects 1 to 3, further including:
an accepting unit that accepts a first user input for selecting a first mode in which the UV irradiation unit emits UV rays to perform full-curing of the varnish at the second position, and a second user input for selecting a second mode in which the UV irradiation unit emits UV rays to perform half-curing of the varnish at the first position, wherein
the position determining unit determines a position of the UV irradiation unit on the basis of the user input regarding the mode to be executed, that was accepted by the accepting unit.

### [Aspect 8]

The sheet embellishing system according to any one of Aspects 1 to 7, wherein
the sheet embellishing system is configured such that a UV irradiation range is narrower when the UV irradiation unit is at the first position, than when the UV irradiation unit is at the second position.

### [Aspect 9]

The sheet embellishing system according to Aspect 8, further including:
a shielding member that has an opening through which UV rays emitted by the UV irradiation unit pass when the UV irradiation unit is at the first position, and that shields UV rays other than the UV rays passing through this opening.

### [Aspect 10]

The sheet embellishing system according to Aspect 9, further including:
an adjusting member that adjusts a size of the opening.

### [Aspect 11]

The sheet embellishing system according to any one of aspects 1 to 7, wherein
the sheet embellishing system is configured such that a UV emission distance is longer when the UV irradiation unit is at the first position, than when the UV irradiation unit is at the second position.

### [Aspect 12]

The sheet embellishing system according to any one of Aspects 1 to 7, wherein
a position of the UV irradiation unit is higher when the UV irradiation unit is at the first position, than when the UV irradiation unit is at the second position.

### [Aspect 13]

The sheet embellishing system according to Aspect 12, further including:
a height adjusting mechanism that adjusts a height of the UV irradiation unit at the first position or at the second position.

### [Aspect 14]

A sheet embellishing method that uses a sheet embellishing system that subjects a sheet to embellishment while conveying the sheet, and that includes
a varnish-discharging unit that discharges varnish that is ultraviolet curable, and applies the varnish to the sheet,
a UV irradiation unit that is capable of being disposed at a first position, and a second position that is on a downstream side in a conveying direction of the sheet from the first position and on an upstream side in the conveying direction from a position at which a transfer device is disposed, and that performs irradiation of the varnish that is applied by UV rays, and
the transfer device that executes predetermined transfer processing on the varnish irradiated by the UV rays,
   the sheet embellishing method including:
determining at which of the first position and the second position the UV irradiation unit is situated; and
controlling the UV irradiation unit such that a total light intensity of UV rays by which the varnish is irradiated by the UV irradiation unit is smaller in a case in which the UV irradiation unit is determined to be situated at the first position as compared to a case in which the UV irradiation unit is determined to be situated at the second position.

### [Aspect 15]

A non-transitory storage medium storing a machine-readable program,
the program being read by a computer installed in a sheet embellishing system that subjects a sheet to embellishment while conveying the sheet, the sheet embellishing system including
   a varnish-discharging unit that discharges varnish that is ultraviolet curable, and applies the varnish to the sheet,
   a UV irradiation unit that is capable of being disposed at a first position, and a second position that is on a downstream side in a conveying direction of the sheet from the first position and on an upstream side in the conveying direction from a position at which a transfer device is disposed, and that performs irradiation of the varnish that is applied by UV rays, and
   the transfer device that executes predetermined transfer processing on the varnish irradiated by the UV rays,
the program causing the computer to execute:
determining at which of the first position and the second position the UV irradiation unit is situated; and
controlling the UV irradiation unit such that a total light intensity of UV rays by which the varnish is irradiated by the UV irradiation unit is smaller in a case in which the UV irradiation unit is determined to be situated at the first position as compared to a case in which the UV irradiation unit is determined to be situated at the second position.

### [Aspect 16]

A sheet embellishing system that subjects a sheet to embellishment while conveying the sheet, the sheet embellishing system including:
a varnish-discharging unit that discharges varnish that is ultraviolet curable, and applies the varnish to the sheet;
a UV irradiation unit that performs irradiation of the varnish that is applied by UV rays; and
a transfer device that executes predetermined transfer processing on the varnish irradiated by the UV rays by the UV irradiation unit, wherein
a first mode in which a varnish-coated region is formed by being coated with varnish alone, and a second mode in which a transfer region is formed by the transfer processing, can be executed by passing the sheet through the sheet embellishing system, and
a total light intensity of UV rays by which the varnish is irradiated by the UV irradiation unit is smaller in a case in which the second mode is executed as compared to a case in which the first mode is executed.

What is claimed is:

1. A sheet embellishing system that subjects a sheet to embellishment while conveying the sheet, the sheet embellishing system comprising:
a varnish-discharging unit that discharges varnish that is ultraviolet (UV) curable, and applies the varnish to the sheet;
a UV irradiation unit that is capable of being disposed at a first position, and a second position that is on a downstream side in a conveying direction of the sheet from the first position and on an upstream side in the conveying direction from a position at which a transfer device is disposed, and that performs irradiation of the varnish that is applied by UV rays;
the transfer device that executes predetermined transfer processing on the varnish irradiated by the UV rays; and
a position determining unit that determines at which of the first position and the second position the UV irradiation unit is situated, wherein
a total light intensity of UV rays by which the varnish is irradiated by the UV irradiation unit is smaller in a case in which the UV irradiation unit is determined to be situated at the first position as compared to a case in which the UV irradiation unit is determined to be situated at the second position.

2. The sheet embellishing system according to claim 1, further comprising:
a moving mechanism that is configured to be capable of changing a position of the UV irradiation unit between the first position and the second position.

3. The sheet embellishing system according to claim 2, wherein
the moving mechanism includes
a slide rail that extends from the first position to the second position, and
a slider that is provided on the UV irradiation unit and that is slidably movable between the first position and the second position following the slide rail.

4. The sheet embellishing system according to claim 2, further comprising:
an accepting unit that accepts a first user input for selecting a first mode in which the UV irradiation unit emits UV rays to perform full-curing of the varnish at the second position, and a second user input for selecting a second mode in which the UV irradiation unit emits UV rays to perform half-curing of the varnish at the first position; and
a position control unit that controls the moving mechanism to move the UV irradiation unit to the second position in a case of accepting the first user input, and to move the UV irradiation unit to the first position in a case of accepting the second user input.

5. The sheet embellishing system according to claim 1, wherein
the position determining unit determines at which of the first position and the second position the UV irradiation unit is situated, on the basis of a sensing result of a position sensor that senses that the UV irradiation unit is situated at the first position and the second position.

6. The sheet embellishing system according to claim 5, further comprising:
an accepting unit that accepts a first user input for selecting a first mode in which the UV irradiation unit emits UV rays to perform full-curing of the varnish at the second position, and a second user input for selecting a second mode in which the UV irradiation unit emits UV rays to perform half-curing of the varnish at the first position; and
an alarm unit that issues a predetermined warning in at least one case of a case in which the first user input is accepted but the UV irradiation unit is not sensed by the position sensor as being situated at the second position, and a case in which the second user input is accepted but the UV irradiation unit is not sensed by the position sensor as being situated at the first position.

7. The sheet embellishing system according to claim 1, further comprising:
an accepting unit that accepts a first user input for selecting a first mode in which the UV irradiation unit emits UV rays to perform full-curing of the varnish at the second position, and a second user input for selecting a second mode in which the UV irradiation unit emits UV rays to perform half-curing of the varnish at the first position, wherein
the position determining unit determines a position of the UV irradiation unit on the basis of the user input regarding the mode to be executed, that was accepted by the accepting unit.

8. The sheet embellishing system according to claim 1, wherein
the sheet embellishing system is configured such that a UV irradiation range is narrower when the UV irradiation unit is at the first position, than when the UV irradiation unit is at the second position.

9. The sheet embellishing system according to claim 8, further comprising:
a shielding member that has an opening through which UV rays emitted by the UV irradiation unit pass when the UV irradiation unit is at the first position, and that shields UV rays other than the UV rays passing through this opening.

10. The sheet embellishing system according to claim 9, further comprising:
an adjusting member that adjusts a size of the opening.

11. The sheet embellishing system according to claim 1, wherein
the sheet embellishing system is configured such that a UV emission distance is longer when the UV irradiation unit is at the first position, than when the UV irradiation unit is at the second position.

12. The sheet embellishing system according to claim 1, wherein
a position of the UV irradiation unit is higher when the UV irradiation unit is at the first position, than when the UV irradiation unit is at the second position.

13. The sheet embellishing system according to claim 12, further comprising:
a height adjusting mechanism that adjusts a height of the UV irradiation unit at the first position or at the second position.

14. A sheet embellishing method that uses a sheet embellishing system that subjects a sheet to embellishment while conveying the sheet, and that includes
a varnish-discharging unit that discharges varnish that is ultraviolet curable, and applies the varnish to the sheet,
a UV irradiation unit that is capable of being disposed at a first position, and a second position that is on a downstream side in a conveying direction of the sheet from the first position and on an upstream side in the conveying direction from a position at which a transfer device is disposed, and that performs irradiation of the varnish that is applied by UV rays, and
the transfer device that executes predetermined transfer processing on the varnish irradiated by the UV rays,
the sheet embellishing method comprising:
determining at which of the first position and the second position the UV irradiation unit is situated; and
controlling the UV irradiation unit such that a total light intensity of UV rays by which the varnish is irradiated by the UV irradiation unit is smaller in a case in which the UV irradiation unit is determined to be situated at the first position as compared to a case in which the UV irradiation unit is determined to be situated at the second position.

15. A non-transitory storage medium storing a machine-readable program,
the program being read by a computer installed in a sheet embellishing system that subjects a sheet to embellishment while conveying the sheet, the sheet embellishing system including
a varnish-discharging unit that discharges varnish that is ultraviolet curable, and applies the varnish to the sheet,
a UV irradiation unit that is capable of being disposed at a first position, and a second position that is on a downstream side in a conveying direction of the sheet from the first position and on an upstream side in the conveying direction from a position at which a transfer device is disposed, and that performs irradiation of the varnish that is applied by UV rays, and
the transfer device that executes predetermined transfer processing on the varnish irradiated by the UV rays,
the program causing the computer to execute:
determining at which of the first position and the second position the UV irradiation unit is situated; and
controlling the UV irradiation unit such that a total light intensity of UV rays by which the varnish is irradiated by the UV irradiation unit is smaller in a case in which the UV irradiation unit is determined to be situated at the first position as compared to a case in which the UV irradiation unit is determined to be situated at the second position.

16. A sheet embellishing system that subjects a sheet to embellishment while conveying the sheet, the sheet embellishing system comprising:
a varnish-discharging unit that discharges varnish that is ultraviolet curable, and applies the varnish to the sheet;
a UV irradiation unit that performs irradiation of the varnish that is applied by UV rays; and
a transfer device that executes predetermined transfer processing on the varnish irradiated by the UV rays by the UV irradiation unit, wherein
a first mode in which a varnish-coated region is formed by being coated with varnish alone, and a second mode in which a transfer region is formed by the transfer processing, can be executed by passing the sheet through the sheet embellishing system, and
a total light intensity of UV rays by which the varnish is irradiated by the UV irradiation unit is smaller in a case in which the second mode is executed as compared to a case in which the first mode is executed.
